(19) United States
(12) Patent Application Publication
(10) Pub. No.: US 2020/0180073 A1
(43) Pub. Date: Jun. 11, 2020

(54) LASER PROCESSING METHODS AND LASER PROCESSING SYSTEMS

(71) Applicant: DGSHAPE Corporation, Hamamatsu-shi (JP)

(72) Inventor: Toshio MAEDA, Hamamatsu-shi (JP)

(21) Appl. No.: 16/682,012

(22) Filed: Nov. 13, 2019

(30) Foreign Application Priority Data
Dec. 7, 2018 (JP) 2018-230301

(51) Int. Cl. B23K 26/08; B23K 26/03

(52) U.S. Cl. CPC B23K 26/0823; B23K 26/035; B23K 26/032

(57) ABSTRACT

In a laser processing method for processing an interior of a material by projecting a laser beam, in which the material is placed in a container filled with a liquid with a refractive index equivalent to a refractive index of the material, at least a portion of the container defines and functions as an incident surface with a certain curvature, and the laser beam is projected to a corrected position through the incident surface, the corrected position having been obtained based on the refractive index of the material and a processing position in the material.

### CROSS REFERENCE TO RELATED APPLICATIONS

This application claims the benefit of priority to Japanese Patent Application No. 2018-230301 filed on Dec. 7, 2018. The entire contents of this application are hereby incorporated herein by reference.

### BACKGROUND OF THE INVENTION

### 1. Field of the Invention

The present invention relates to laser processing methods and laser processing systems.

### 2. Description of the Related Art

Laser processing devices that process materials using laser beams are known (see JP-A-2003-19587).

To perform processing somewhere inside a material, it is necessary to consider its refractive index. FIGS. 7A and 7B are diagrams schematically showing the interior of the material M. The processing position P is where processing should actually be performed (e.g., positions corresponding to the outer edge of a target object). The refractive index of the material M is denoted by “n.” Although the processing described herein is assumed to be performed in the atmosphere, the materials and the regions around the optical paths are not necessarily located in the atmosphere and these could be located in a vacuum, too, depending on the materials and processing conditions.

Under a hypothetical situation, a laser beam L is projected when the processing position P is set to coincide with the focus of the laser beam L. In this case, the length of the optical path of the laser beam L becomes affected by the refractive index n and increases by an amount determined depending on the refractive index. Thus, the laser beam L is projected to a position denoted by the point P′ (see FIG. 7A). That is, the processing is performed at the point P′, making it impossible to perform processing at the processing position P.

To perform processing at the processing position P, it is necessary to correct the position to which the laser beam L is projected in consideration of the refractive index n. Specifically, a surface S onto which the laser beam is directed is defined, correction is performed in such a way that the length of the optical path from the surface S to the processing position P becomes 1/n, and a corrected position W is obtained. By projecting the laser beam L with its focus coinciding with the corrected position W, processing can be performed at the processing position P (see FIG. 7B).

Furthermore, when the laser beam is projected into the material, it is necessary to consider the refraction at the material surface.

FIG. 8 is a diagram schematically showing the interior of the material M. As shown in FIG. 8, it is assumed that the laser beam L is projected to the surface S of the material M at a certain angle relative to the surface S, with the corrected position W coinciding with the focus of the laser beam L. In this case, the laser beam L bends as it passes through the surface S of the material M and it is actually projected to the position denoted by P″.

Therefore, to perform processing at the processing position P, it is necessary to make adjustment such that the laser beam L (the optical axis OA of the laser beam L) is directed at right angles to the surface S of the material M (see FIG. 7B).

FIG. 9 is a diagram showing an example of processing an ellipse E in the material M. FIG. 9 shows only a few of the processing positions (processing positions P1 to P7). The processing positions P1 to P7 are arranged at equal distances along the periphery of the ellipse E. The laser beams that are projected to these processing positions have the same power.

As shown in FIG. 9, in case processing is performed at each processing position by projecting a laser beam at right angles to the surface S of the material M, the distances between the projected laser beams become uneven. For example, the distance s1 between the optical axis OA3 of the laser beam L3 projected to the processing position P3 and the optical axis OA4 of the laser beam L4 projected to the processing position P4 is less than the distance s2 between the optical axis OA2 of the laser beam L2 projected to the processing position P2 and the optical axis OA3 of the laser beam L3 projected to the processing position P3. Therefore, the laser beams to be applied to the material at these processing positions have different energy levels, which possibly prevent uniform processing or cause processing of a portion that is not required to be processed. In addition, to perform processing at the processing position P7, the laser beam L7 (optical axis OA7) passes through the inside of the ellipse E (see FIG. 9), which could cause processing of the portion that is not required to be processed (a region denoted by diagonal hatching in FIG. 9).

Furthermore, to direct the laser beam at right angles to the material surface, it is necessary to achieve precise control in the processing device. That is, when processing a material, it is necessary to accurately determine, for each processing position, the positions of the material and the projector that projects laser beams. If the positioning is not accurate or if any displacement occurs during processing, the laser beam cannot be directed at right angles to the material surface. As a result, the portion that is not required to be processed could possibly be processed.

### SUMMARY OF THE INVENTION

Preferred embodiments of the present invention provide laser processing methods and laser processing systems with each of which interiors of materials are able to be processed without being affected by refractions at surfaces of and inside of the materials.

According to a preferred embodiment of the present invention, a laser processing method includes placing a material in a container filled with a liquid with a refractive index equivalent to a refractive index of the material, at least a portion of the container defining and functioning as an incident surface with a curvature; processing an interior of the material by projecting a laser beam to a corrected position through the incident surface; wherein the corrected position is obtained based on the refractive index of the material and a processing position in the material.

In addition, another preferred embodiment of the present invention is a laser processing system for processing an interior of a material by projecting a laser beam, including a container, at least a portion of the container including an incident surface with a certain curvature, a projector to project a laser beam, a holder to hold the material placed in the container filled with a liquid with a refractive index equivalent to a refractive index of the material, a driver to move at least one of the projector and the holder, and a controller to control the projector and the driver such that a laser beam is projected to a corrected position through the incident surface, wherein the corrected position is obtained based on the refractive index of the material and a processing position in the material.

Other features of preferred embodiments of the present invention will be disclosed in the description of this specification.

According to preferred embodiments of the present invention, it is possible to process the interior of materials without being affected by the refractions at the surface of and inside of the materials.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing a configuration of a laser processing system, a CAM system, and a CAD system according to a preferred embodiment of the present invention.

FIG. 2A is a diagram showing a container according to a preferred embodiment of the present invention.

FIG. 2B is a diagram showing a container and a material according to a preferred embodiment of the present invention.

FIG. 2C is a diagram showing a container and a material according to a preferred embodiment of the present invention.

FIG. 3 is a diagram showing a container according to a preferred embodiment of the present invention.

FIG. 4 is a diagram showing a container according to a preferred embodiment of the present invention.

FIG. 5 is a flowchart for explaining a laser processing method according to a preferred embodiment of the present invention.

FIG. 6 is a diagram showing a container and a material according to a preferred embodiment of the present invention.

FIG. 7A is a diagram showing the interior of a material.

FIG. 7B is a diagram showing the interior of a material.

FIG. 8 is a diagram showing the interior of a material.

FIG. 9 is a diagram showing the interior of a material.

### DETAILED DESCRIPTION OF THE PREFERRED EMBODIMENTS

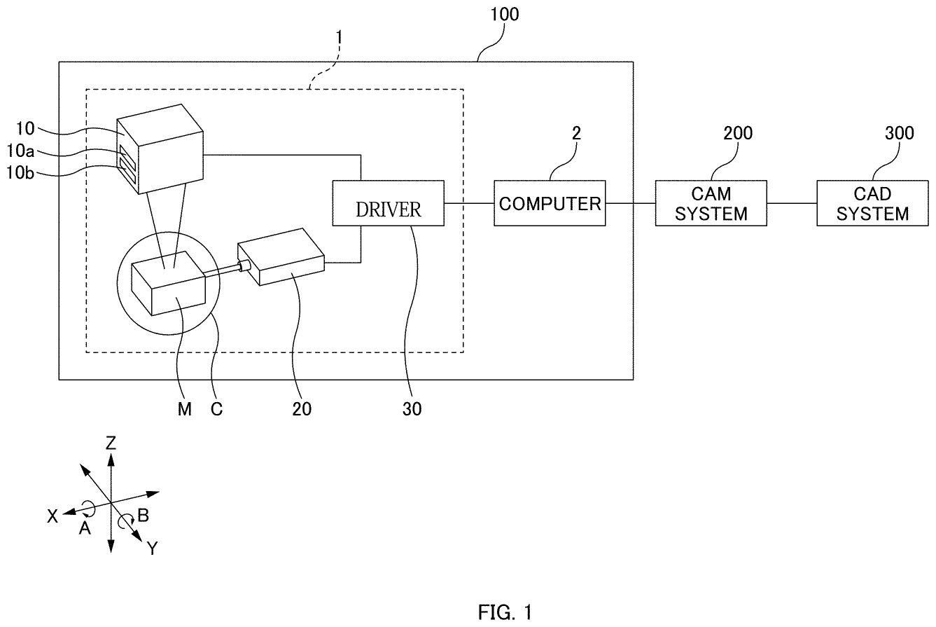

FIG. 1 is a diagram schematically showing a laser processing system 100, a CAM system 200, and a CAD system 300 according to a preferred embodiment of the present invention.

The laser processing system 100 produces a target object by processing a material in a non-contact manner using a laser beam or beams.

The CAM system 200 generates data used for processing that are used in the laser processing system 100. The data used for processing includes information about processing positions in the material (e.g., three-dimensional coordinate vales), a value of the refractive index of the material used or information related to the projection of each laser beam (the open/close of a shutter, control information for outputs, information about an optical system, etc.) or the like.

The CAD system 300 generates shape data representing the shape of a target object. The shape data is, for example, a three-dimensional data of the target object. Specifically, it is STL data or solid data used in three-dimensional CAD, or data such as 3 MF or AMF used in 3D printers. The CAM system 200 and the CAD system 300 may be integrated into a single system.

The laser processing system 100 includes a laser processing device 1 and a computer 2. The laser processing system 100 processes materials based on the data used for processing that has been generated in the CAM system 200. The laser processing system 100, however, can be defined by the laser processing device 1 alone when the functions of the computer 2 are integrated into the laser processing device 1.

By projecting laser beams onto and into the material M based on the data used for processing, the laser processing device 1 processes the surface and the interior of the material M.

The laser processing device 1 preferably includes the projector 10, a holder 20, and a driver 30, for example.

The projector 10 projects laser beams to the material M. The projector 10 includes a laser oscillator 10a and a group of lenses 10b or others to focus the laser beam from the oscillator 10a at a certain position. The laser oscillator 10a may be provided outside the laser processing device 1. The projector 10 may include an adjustment mechanism (not shown) that adjusts the focal lengths of the group of lenses 10b to change the positions at which the laser beams are focused.

The lasers used preferably are ultrashort laser pulses, for example. Ultrashort laser pulses have a duration ranging from a few femtoseconds to a few picoseconds. By exposing the material to ultrashort laser pulses at processing positions for a short period of time, ablation (non-thermal processing) can be performed. Ablation is a technique of ionizing or converting the material into plasma with a laser beam. The material that has been ionized or converted into plasma (vaporized) is instantaneously turned into plasma and, if not scattered within an object, it is re-solidified to form a modified layer that differs from fine cavities, cracks, and surroundings in terms of their densities. The ablation is less likely to cause thermal damages at each processing position than typical thermal processing.

The material M in this preferred embodiment is transparent to laser beams (transparent material). Examples of the transparent materials include glass materials such as glass ceramics, resin materials with high light transmittance (such as acrylic resins), zirconia-based light-transmitting materials (composite materials such as zirconia-containing glass ceramics or zirconia alone with a certain transmittance). For the light transmittance of the transparent materials, any value will suffice as long as the laser beams reach the processing position in the material and processing can be performed.

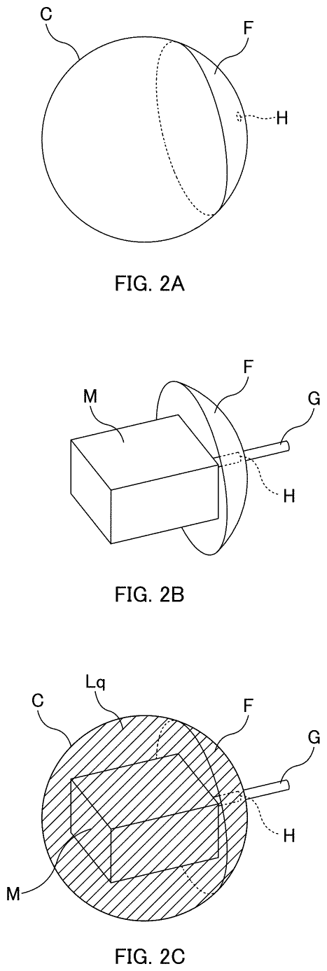

In performing laser processing in this preferred embodiment, the material M is placed in a container C. The container C is a hollow member at least a portion of which defines and functions as an incident surface with a certain curvature. The container C according to this preferred embodiment is a sphere (see FIG. 2A etc.). That is, the entire container C defines and functions as the incident surface.

The incident surface of the container C is a curved surface made of a material that is highly transparent to laser beams. An appropriate material is selected depending on wavelength properties of the laser beams used. The laser beams emitted from the projector 10 are projected onto the material M through the incident surface.

In addition, the container C is filled with a liquid with a refractive index that is equivalent to the refractive index of the material M. An appropriate liquid can be selected depending on the type of the material M (the refractive index of the material M). For example, when the material M is glass or glass ceramics, its refractive index is approximately 1.5. In this case, a liquid with a refractive index of around 1.5 (such as oils and fats that are used for oil-immersion lenses) can be used. Note that the refractive index of the liquid is not required to be exactly the same as that of the material. Their refractive indices may be different from each other as long as the error (the degree of refraction due to the change in terms of refractive index) caused as the laser beams passes through the liquid and enters the material is within an allowable range.

Any methods can be used for placing the material M in the container C and filling the container with liquid. For example, a portion of the container C shown in FIG. 2A defines and functions as a removable lid F. An operator removes the lid F and secures the material M to the lid F. Specifically, the operator secures the material M to the lid F by engaging a held portion G bonded to the material M with a hole H in the lid F (see FIG. 2B). The held portion G is held by the holder 20. In the example shown in FIG. 2B, the held portion G is a pin-shaped member.

The operator fills the container C with a liquid Lq with a refractive index equivalent to that of the material M and then attaches the lid F to which the material M is secured (see FIG. 2C). In the example shown in FIG. 2C, the hole H is blocked with the held portion G, so the liquid Lq will never leak out of the container C. Note that, in the container C, the material M is preferably placed in such a way that its center coincides with the center of the container C.

The holder 20 holds the material M placed in the container C. Any methods can be used to hold the material M as long as the material M held can be moved along a driving axis or axes of the processing device 1. For example, the holder 20 may hold the container C itself or hold the held portion G protruding from the container C (see FIG. 2C).

The driver 30 moves at least one of the projector 10 and the holder 20. The driver 30 includes a servo motor to perform driving, and other components. In this preferred embodiment, the driver 30 can adjust the positional relationship between the projector 10 and the holder 20 (the material M held by the holder 20) by moving the projector 10 and the holder 20 along five driving axes (the x-, y-, and z-axes as well as the rotation axis around the x-axis (A-rotation axis) and the rotation axis around the y-axis (B-rotation axis)).

For example, in case the driver 30 moves the holder 20 in the direction of the x-axis with the container C being held, the container C (the material M secured to the container C) also moves in the direction of the x-axis along with the movement of the holder 20. Alternatively, in case the driver 30 rotates the holder 20 along the A-rotation axis with the holder 20 holding the container C in a rotatable manner, the container C (the material M secured to the container C) also rotates along the A-rotation axis as the holder 20 rotates. In this case, it is preferable that the material M is placed in the container C in such a way that the rotation axis of the material M coincides with that of the container C.

The range within which the projector 10 and the holder 20 can move is not limited. For example, the projector 10 and the holder 20 may be configured such that the projector 10 is movable only in the direction of the z-axis and the holder 20 is movable in the other four directions. Alternatively, the projector 10 and the holder 20 may be configured such that the projector 10 is fixed and the holder 20 is movable in the five directions. Alternatively, both of the projector 10 and the holder 20 may be movable in the same direction (e.g., the direction of the z-axis). Furthermore, the number of the driving axes of the laser processing device 1 is not limited to five. For example, the laser processing device 1 may have three driving axes (the x-, y-, and z-axes).

Furthermore, as described above, what is required is that an incident surface is provided at least a portion of the container C. For example, the portion other than the incident surface may have a rectangular or substantially rectangular shape defined by a flat plane. Alternatively, the portion other than the incident surface may be formed of a material that is not transparent to laser beams.

In addition, in case the holder 20 holds the container C, it is preferable that the holding is achieved without affecting the projection of the laser beams. Accordingly, for example, in case the container C is provided with a portion other than the incident surface, it is preferable that the holder 20 holds that portion other than the incident surface.

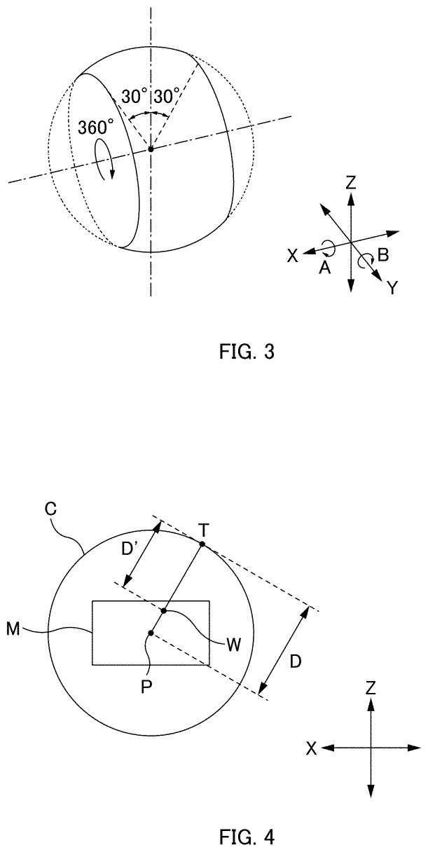

In the container C, where the incident surface is provided can be determined depending on the structure of the holder 20 of the laser processing device 1, and the range within which the driver 30 can drive the projector 10 and the holder 20. For example, it is assumed that the holder 20 can hold the container C such that the container C can be rotated by 360 degrees about an axis in the direction of the x-axis and turned about an axis in the direction of the y-axis by plus and minus 30 degrees relative to the z-axis (0 degrees). In this case, it is preferable that the container C is configured to have, at least, the incident surface extending over the range of 360 degrees about an axis in the direction of the x-axis and over the range of plus and minus 30 degrees relative to the axis Zp in the direction of the z-axis passing through the center of the container C (the center of the material M) (see FIG. 3). Note that the portion other than the incident surface is denoted by broken lines in FIG. 3.

The computer 2 controls operations of various structures of the laser processing device 1. For example, the computer 2 controls the driver 30 to adjust the positional relationship of the projector 10 and the material M held by the holder 20. Alternatively, the computer 2 controls the projector 10 and the driver 30 such that laser beams are projected into the material M based on the data used for processing. The computer 2 is an example of the “controller” provided in the laser processing system 100.

The computer 2 according to this preferred embodiment controls the projector 10 and the driver 30 such that laser beams are projected to a corrected position through the incident surface of the container C, the corrected position having been obtained based on the refractive index of the material and a processing position in the material. The processing position is where processing should be performed using a laser beam. The corrected position is a set position to which a laser beam is focused.

For example, as shown in FIG. 4, it is assumed that a laser beam is projected to the position P in the material M placed in the container C and processing is performed. The data used for processing generated by the CAM system 200 is assumed to include position information for the processing position P and information about the refractive index n of the material M.

In this case, the computer 2 defines a given plane including the processing position P and aligns the direction normal to that plane and the direction of the optical axis of the laser beam L. Next, the computer 2 calculates the distance D from the processing position P to the position T on the incident surface through which the laser beam L is directed. Furthermore, the computer 2 calculates the distance D′ by correcting the distance D using the refractive index n and determines, as the corrected position W, the position spaced away from the position T in the direction of the optical axis of the laser beam by an amount equal to the distance D′. Then, the computer 2 controls the driver 30 such that the laser beam is focused to the corrected position W through the incident surface of the container C, and determines the positions of the projector 10 and the material M. Specifically, the computer 2 adjusts the position(s) and the orientation(s) of the projector 10 and the material M (the container C) such that the direction of the optical axis of the laser beam L coincides with the direction normal to the plane including the corrected position W. Thereafter, the computer 2 controls the projector 10 and causes the laser beam to be projected toward the corrected position W.

The corrected position W is determined in consideration of the refractive index n of the material M. That is, the laser beam L emitted to the corrected position W actually reaches the processing position P (focused at the processing position P). In this case, the material M is placed in the container C filled with a liquid with a refractive index equivalent to that of the material M. Accordingly, no refraction occurs at the surface of the material M even when the surface of the material M is not flat or when the laser beam L is directed onto the material M at an angle other than the right angle.

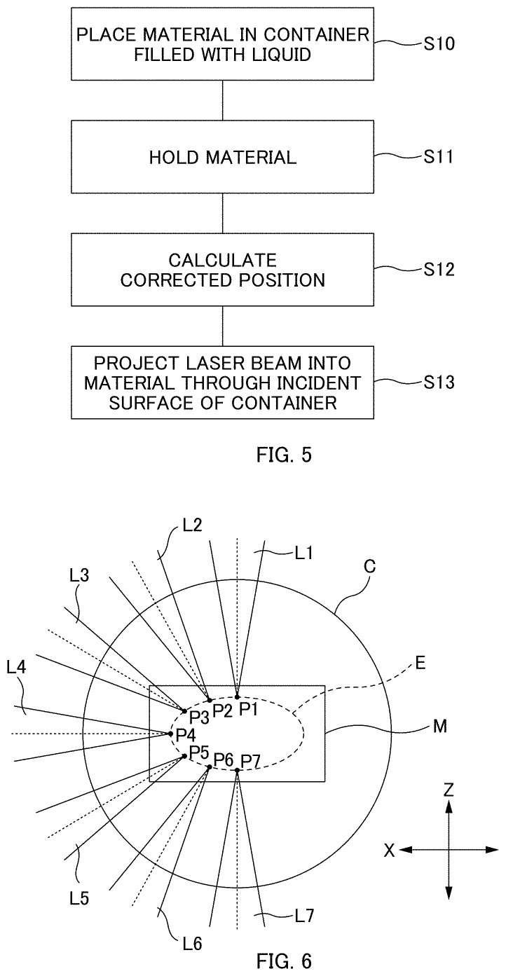

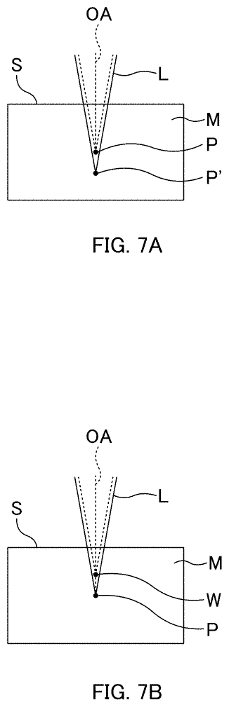

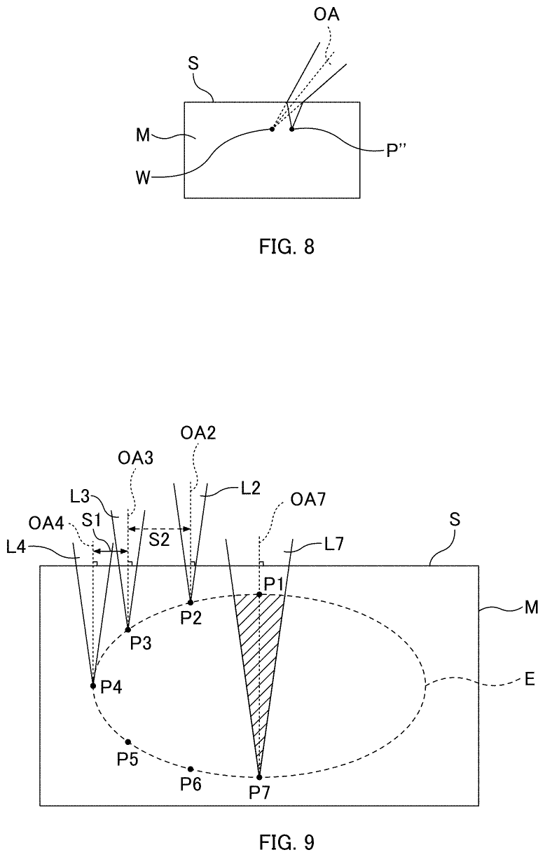

Next, as shown in FIG. 5, the laser processing method according to this preferred embodiment is described. The laser processing method according to this preferred embodiment is performed by the laser processing system 100. In this example, processing is performed based on the data used for processing generated by the CAM system 200 in advance.

An operator fills the container C at least a portion of which defines and functions as the incident surface with a certain curvature, with a liquid with a refractive index equivalent to that of the material M and places the material M in the container C (place material in container filled with liquid; step 10).

The operator attaches the container C with the material placed therein to the holder 20. The holder 20 holds the material M placed in the container C (hold material; step 11).

The computer 2 calculates a corrected position for a laser beam based on the refractive index of the material M and the processing position in the material M included in the data used for processing (calculate corrected position; step 12). In practice, a plurality of processing positions are present depending on the shape of a target object. The computer 2 calculates corrected positions for these processing positions.

The computer 2 controls the projector 10 and the driver 30 such that a laser beam is projected to the corrected position obtained at the step 12 through the incident surface of the container C (project laser beam into material through incident surface of container; step 13).

It should be noted that the above-mentioned example has been described in terms of the case in which the computer 2 calculates the corrected position based on the refractive index of the material and the processing position included in the data used for processing, but the present invention is not limited thereto. For example, the CAM system 200 may calculate the corrected position and that information can be included in advance in the data used for processing. In this case, the computer 2 projects the laser beam to the corrected position included in the data used for processing.

As described above, the laser processing method according to this preferred embodiment processes the interior of the material M by projecting a laser beam or laser beams. The material M is placed in the container C filled with a liquid with a refractive index equivalent to that of the material M. At least a portion of the container C defines and functions as an incident surface with a certain curvature. The laser processing method according to this preferred embodiment projects a laser beam to the corrected position through the incident surface, the corrected position having been obtained based on the refractive index of the material M and the processing position in the material M.

In addition, the laser processing system 100 according to this preferred embodiment processes the interior of the material M by projecting a laser beam or laser beams. The laser processing system 100 includes the container C at least a portion of which defines and functions as an incident surface with a certain curvature, the projector 10 to project laser beams, the holder to hold the material M placed in the container C filled with a liquid with a refractive index equivalent to that of the material M, the driver 30 to move at least one of the projector 10 and the holder 20, and the computer 2 to control the projector 10 and the driver 30 such that a laser beam is projected to a corrected position through the incident surface, the corrected position having been obtained based on the refractive index of the material M and a processing position in the material M.

For example, FIG. 6 is a diagram showing an example of processing an ellipse E in the material M. FIG. 6 shows only a few of the processing positions (processing positions P1 to P7). The processing positions P1 to P7 are arranged at equal or substantially equal distances along the periphery of the ellipse E.

As shown in FIG. 6, in the laser processing method and the laser processing system 100 according to this preferred embodiment, laser beams can be directed into the incident surface from any directions depending on the processing positions because the incident surface for the laser beams is a curved surface. Accordingly, laser beams can be adjusted such that they are projected at an equal or substantially equal distance. Thus, no difference occurs in terms of the energy level of the laser beams at different processing positions, allowing for uniform processing. Furthermore, since the laser beams can be projected to the material M from any directions, it is possible to make adjustment to prevent the laser beam L from passing through the ellipse E even when a shape like the ellipse E is processed. Therefore, it is possible to prevent any portion that should not be processed from being processed. Furthermore, the material M is placed in the container C filled with a liquid with a refractive index equivalent to that of the material M. Thus, the laser beams do not bend at the surface of the material M even when the surface of the material M is not flat or the angle of incidence of the laser beam to the material M is not the right angle (see FIG. 6). Accordingly, the projector 10 and the material M can be positioned more easily. In addition, laser processing to processing positions can be performed without being affected by the refractive index in the material M by projecting a laser beam to a corrected position obtained based on the processing position and the refractive index of the material M. That is, with the laser processing system 100 according to this preferred embodiment and the laser processing method using this system, it is possible to process the interior of materials without being affected by the refractions at the surface of and in the materials.

Note that a method of directing laser beams onto different surfaces of the material depending on the shape of a target object rather than directing a laser beam only through the single surface S as shown in FIG. 9 can be contemplated. However, such a method makes the generation of the data used for processing complicated. For example, for each processing position, it is necessary to define the surface of the material onto which the laser beam or beams are directed, to obtain the length of the optical path from the surface to the processing position, and to correct the optical length thus obtained using the refractive index. Furthermore, when a target object having an intricate shape is processed, it could be possible that laser beams are directed onto different surfaces or with different settings to direct them at right angles to the material, even for adjacent processing positions. In such cases, the data used for processing get complicated. Furthermore, in case processing is performed based on such data used for processing, the positioning of the projector and the material M as well as travel paths between the processing positions get complicated, increasing the length of time required for processing.

In addition, in place of directing the laser beams to the material surface at right angles, the length of the optical path(s) can be corrected depending on the angle of incidence. In such cases, however, it becomes necessary to determine the angle of incidence for each processing position and correct the length of the optical path depending on the angle of incidence, which makes the generation of the data used for processing more complicated. In addition, since it becomes necessary to determine the positions of the projector 10 and the material M depending on the angle of incidence, the control of the processing device also gets complicated.

On the other hand, in the laser processing method and the laser processing system 100 according to this preferred embodiment, it is unnecessary to define for each processing position the surface onto which the laser beam or beams are projected because the incident surface for the laser beams is curved. This serves to simplify the generation of the data used for processing in the CAM system 200 and the correction processing based on the refractive index.

Furthermore, in this preferred embodiment, laser processing of the material M is performed in the container C. Thus, fumes and gases generated by the laser processing stay in the container C; therefore, their scattering to the outside of the device is prevented. In addition, since the container C is filled with liquid, it is possible to easily remove fumes adhered to the material by, for example, the vibrations that occur as the container C moves. Therefore, the efficiency of the laser processing is increased.

Furthermore, in this preferred embodiment, since the material M is placed in the container C filled with liquid, scattering at the material surface is reduced. Therefore, it is possible to keep transparency of the material. For example, when the material has a rough surface, laser beams scatter at the surface and are attenuated. Thus, in case the laser beams are directly directed into the material, it is necessary to perform polishing or chemical mirror-finishing of the material surface or coating. On the other hand, in this preferred embodiment, such treatments are unnecessary because the material M is placed in liquid.

Furthermore, in the laser processing system 100 according to this preferred embodiment, the holder 20 rotatably holds the material M and the material M is placed in the container C such that the rotation axis of the material M coincides with the rotation axis of the container C. This structure facilitates the positioning of the projector 10 relative to the material M.

Furthermore, the container C preferably is a sphere, for example. When the container C is a sphere, laser beams can be directed into the material M from any directions. Thus, even when the laser processing device 1 has a narrow driving range or a target object has an intricate shape, laser beams can easily be projected to the processing positions.

Furthermore, the laser processing method described in the above-mentioned preferred embodiments can be configured as a program. Such program can be executed by the computer 2.

The program can be obtained by directly downloading it by the computer 2 from a server device (not shown) or a website accessible by the server device. Alternatively, it is also possible to supply a program to a computer 2 using a non-transitory computer readable medium with an executable program thereon, in which the program is stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A laser processing method comprising:
placing a material in a container filled with a liquid with a refractive index equivalent to a refractive index of the material, at least a portion of the container defining and functioning as an incident surface with a curvature;
processing an interior of the material by projecting a laser beam to a corrected position through the incident surface; wherein
the corrected position is obtained based on the refractive index of the material and a processing position in the material.

2. A laser processing system for processing an interior of a material by projecting a laser beam, the laser processing system comprising:
a container, at least a portion of the container including an incident surface with a curvature;
a projector to project a laser beam;
a holder to hold the material placed in the container filled with a liquid with a refractive index equivalent to a refractive index of the material;
a driver to move at least one of the projector and the holder; and
a controller to control the projector and the driver such that a laser beam is projected to a corrected position through the incident surface; wherein
the corrected position is obtained based on the refractive index of the material and a processing position in the material.

3. The laser processing system according to claim 2, wherein
the holder rotatably holds the material; and
the material is placed in the container such that a rotation axis of the material coincides with a rotation axis of the container.

4. The laser processing system according to claim 2, wherein the container is a sphere.
